(19) United States
(12) Patent Application Publication
(10) Pub. No.: US 2021/0216506 A1
(43) Pub. Date: Jul. 15, 2021

(54) FILE COMPRESSION SYSTEMS AND METHODS FOR USE IN MULTI-FILE DATA STORES

(71) Applicant: Optum, Inc., Minnetonka, MN (US)

(72) Inventor: Jason R. Robinson, La Jolla, CA (US)

(21) Appl. No.: 16/741,490

(22) Filed: Jan. 13, 2020

(51) Int. Cl. G06F 16/174; G06F 16/176

(52) U.S. Cl. CPC G06F 16/1744; G06F 16/176; G06F 16/1748

(57) ABSTRACT

Systems and methods enable compression of chronological data stored within a hierarchical data storage repository by identifying related data files generated at different times, wherein the related data files comprises a first data file and a second data file, and wherein the second data file was generated chronologically after the first data file; identifying duplicative data existing in both the first data file and the second data file; deleting the duplicative data from the first data file; and generating a link between the first data file and the second data file to enable retrieval of the duplicative data during display of contents of the first data file.

### BACKGROUND

As the prevalence of electronic file storage continues to grow, the necessity of maintaining adequate storage resources for data files becomes increasingly paramount. Although increases in data usage (and data storage) often prompt the addition of new data storage resources, compression technologies may be utilized to more efficiently utilize existing data storage resources, thereby minimizing the necessity of constantly increasing the amount of storage resources available.

Accordingly, as electronic data storage remains pervasive, a need constantly exists for new and improved concepts for increasing the efficiency with which existing electronic storage resources are utilized.

### BRIEF SUMMARY

Embodiments as discussed herein provide data compression concepts for use with data storage systems configured for storing a plurality of data files within a data storage hierarchy, wherein individual data files are characterized by known data file types, and data files of a common data file type are generated chronologically. Data files may be further characterized by defined groupings to further designate relevant similarities between particular data files. Such data compression concepts may be particularly suitable for compressing data files of medical documentation, in which individual data files are grouped by patient and/or episode, data files are characterized as being one of a plurality of data types (e.g., administration data files, lab reports, medication management reports, discharge reports, and/or the like), and data files are generally created chronologically (e.g., a preliminary discharge report is generated prior to generation of a second discharge report). Various embodiments provide compression by maintaining all data within a most-recent data file of a particular grouping and file type, and maintaining only data that varies from the most-recent data file within historical data files (i.e., files other than the most recent) of the same grouping and file type.

Various embodiments are directed to a computer-implemented method for compressing chronological data within a data storage repository, the method comprising: identifying related data files generated at different times, wherein the related data files comprise a first data file and a second data file, and wherein the second data file was generated chronologically after the first data file; identifying duplicative data existing in both the first data file and the second data file; deleting the duplicative data from the first data file; and generating a link between the first data file and the second data file to enable retrieval of the duplicative data during display of contents of the first data file.

In various embodiments, identifying related data files comprises: identifying a plurality of data files having a shared data file type; and identifying, within the plurality of data files having a shared data file type, the first data file and the second data file as chronologically adjacent data files. Moreover, the method may further comprise, after deleting the duplicative data from the first data file, identifying a third data file from the plurality of data files having a shared data file type, wherein the third data file is a most-recent data file; identifying duplicative data existing in both the second data file and the third data file; deleting the duplicative data from the second data file; generating a link between the first data file and the third data file to enable retrieval of duplicative data during display of the contents of the first data file; and generating a link between the second data file and the third data file to enable retrieval of duplicative data during display of contents of the second data file. In various embodiments, identifying related data files comprises identifying related data files within a hierarchical data storage repository. Moreover, the method of certain embodiments comprises displaying, via a graphical user interface, the contents of the first data file by: retrieving the contents of the first data file; retrieving, via the link, the contents of the second data file; displaying a composite graphical user interface comprising the contents of the first data file with the duplicative data retrieved from the second data file. In certain embodiments, the composite graphical user interface comprises the contents of the first data file displayed with a first formatting, and the duplicative data retrieved from the second data file displayed with a second formatting. In certain embodiments, identifying duplicative data existing in both the first data file and the second data file comprises: segmenting contents of the first data file into a plurality of data segments; segmenting contents of the second data file into a plurality of data segments; and comparing data within matching data segments of the first data file and the second data file to identify duplicative data.

Various embodiments are directed to a system for compressing chronological data within a data storage repository, the system comprising one or more memory storage areas and one or more processors, wherein the one or more processors are collectively configured to: identify related data files generated at different times, wherein the related data files comprise a first data file and a second data file, and wherein the second data file was generated chronologically after the first data file; identify duplicative data existing in both the first data file and the second data file; delete the duplicative data from the first data file; and generate a link between the first data file and the second data file to enable retrieval of the duplicative data during display of contents of the first data file.

In certain embodiments, identifying related data files comprises: identifying a plurality of data files having a shared data file type; and identifying, within the plurality of data files having a shared data file type, the first data file and the second data file as chronologically adjacent data files. Moreover, the one or more processors may be further configured to, after deleting the duplicative data from the first data file, identify a third data file from the plurality of data files having a shared data file type, wherein the third data file is a most-recent data file; identify duplicative data existing in both the second data file and the third data file; delete the duplicative data from the second data file; generate a link between the first data file and the third data file to enable retrieval of duplicative data during display of the contents of the first data file; and generate a link between the second data file and the third data file to enable retrieval of duplicative data during display of contents of the second data file.

In various embodiments, identifying related data files comprises identifying related data files within a hierarchical data storage repository. In certain embodiments, the one or more processors are further configured to: display, via a graphical user interface, the contents of the first data file by: retrieving the contents of the first data file; retrieving, via the link, the contents of the second data file; displaying a composite graphical user interface comprising the contents of the first data file with the duplicative data retrieved from the second data file. In various embodiments, the composite graphical user interface comprises the contents of the first data file displayed with a first formatting, and the duplicative data retrieved from the second data file displayed with a second formatting. Moreover, identifying duplicative data existing in both the first data file and the second data file may comprise: segmenting contents of the first data file into a plurality of data segments; segmenting contents of the second data file into a plurality of data segments; and comparing data within matching data segments of the first data file and the second data file to identify duplicative data.

Various embodiments are directed to a computer program product comprising a non-transitory computer readable medium having computer program instructions stored therein, the computer program instructions when executed by a processor, cause the processor to: identify related data files generated at different times, wherein the related data files comprise a first data file and a second data file, and wherein the second data file was generated chronologically after the first data file; identify duplicative data existing in both the first data file and the second data file; delete the duplicative data from the first data file; and generate a link between the first data file and the second data file to enable retrieval of the duplicative data during display of contents of the first data file.

In certain embodiments, identifying related data files comprises: identifying a plurality of data files having a shared data file type; and identifying, within the plurality of data files having a shared data file type, the first data file and the second data file as chronologically adjacent data files. Moreover, the computer program instructions when executed by a processor, may cause the processor to, after deleting the duplicative data from the first data file, identify a third data file from the plurality of data files having a shared data file type, wherein the third data file is a most-recent data file; identify duplicative data existing in both the second data file and the third data file; delete the duplicative data from the second data file; generate a link between the first data file and the third data file to enable retrieval of duplicative data during display of the contents of the first data file; and generate a link between the second data file and the third data file to enable retrieval of duplicative data during display of contents of the second data file.

In certain embodiments, identifying related data files comprises identifying related data files within a hierarchical data storage repository. Moreover, the computer program instructions when executed by a processor, may cause the processor to: display, via a graphical user interface, the contents of the first data file by: retrieving the contents of the first data file; retrieving, via the link, the contents of the second data file; displaying a composite graphical user interface comprising the contents of the first data file with the duplicative data retrieved from the second data file. In certain embodiments, the composite graphical user interface comprises the contents of the first data file displayed with a first formatting, and the duplicative data retrieved from the second data file displayed with a second formatting. Moreover, in certain embodiments, identifying duplicative data existing in both the first data file and the second data file comprises: segmenting contents of the first data file into a plurality of data segments; segmenting contents of the second data file into a plurality of data segments; and comparing data within matching data segments of the first data file and the second data file to identify duplicative data.

### BRIEF DESCRIPTION OF THE SEVERAL VIEWS OF THE DRAWINGS

Reference will now be made to the accompanying drawings, which are not necessarily drawn to scale, and wherein:

FIG. 1 is a diagram of a compression system that can be used in conjunction with various embodiments of the present invention;

FIG. 2 is a schematic of an analytic computing entity in accordance with certain embodiments of the present invention;

FIG. 3 is a schematic of a user computing entity in accordance with certain embodiments of the present invention;

FIG. 4 is an example user interface incorporating aspects of the present invention;

FIGS. 5-11 graphically illustrate functionalities of certain embodiments of the present invention;

FIG. 12 is a flowchart illustrating various steps associated with certain embodiments of the present invention;

FIG. 13 graphically illustrates segmenting of data files in accordance with one embodiment of the present invention;

FIG. 14 graphically illustrates the results of compression of data files in accordance with one embodiment of the present invention;

FIGS. 15A-15B graphically illustrate compression processes in accordance with various embodiments of the present invention; and

FIGS. 16A-16B graphically illustrate compression considerations in accordance with various embodiments of the present invention.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

### I. Computer Program Products, Methods, and Computing Entities

Embodiments of the present invention may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

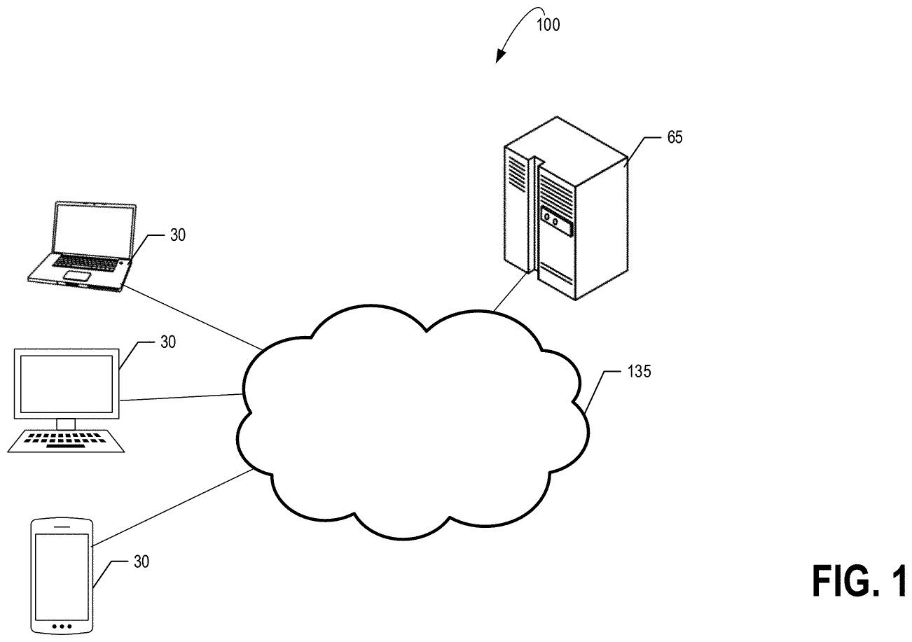

FIG. 1 provides an illustration of a compression system 100 that can be used in conjunction with various embodiments of the present invention. As shown in FIG. 1, the compression system 100 may comprise one or more analytic computing entities 65, one or more user computing entities 30, one or more networks 135, and/or the like. Each of the components of the system may be in electronic communication with, for example, one another over the same or different wireless or wired networks 135 including, for example, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities, the various embodiments are not limited to this particular architecture.

a. Exemplary Analytic Computing Entity

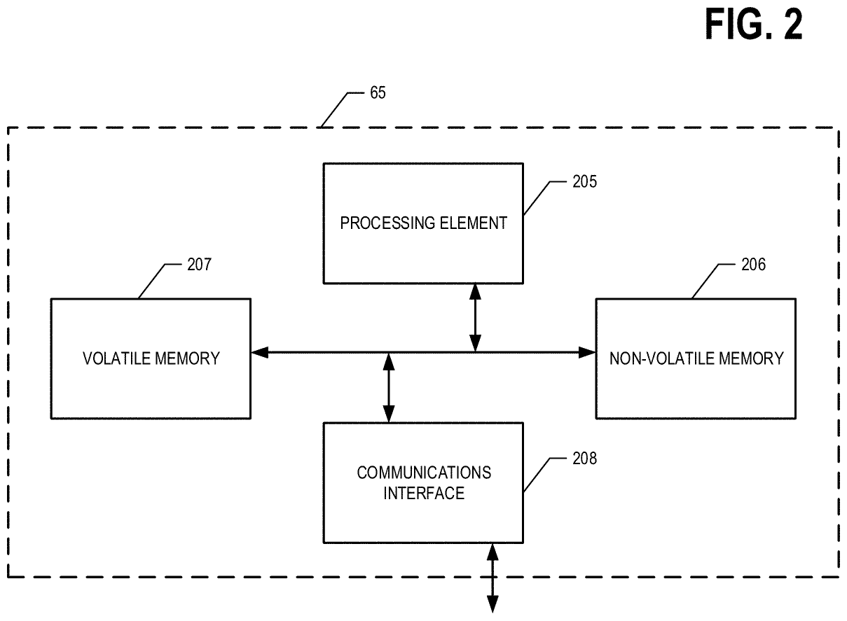

FIG. 2 provides a schematic of an analytic computing entity 65 according to one embodiment of the present invention. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the analytic computing entity 65 may also include one or more network and/or communications interfaces 208 for communicating with various computing entities, such as by communicating data, content, information, and/or similar terms used herein interchangeably that can be transmitted, received, operated on, processed, displayed, stored, and/or the like. For instance, the analytic computing entity 65 may communicate with other computing entities 65, one or more user computing entities 30, and/or the like.

As shown in FIG. 2, in one embodiment, the analytic computing entity 65 may include or be in communication with one or more processing elements 205 (also referred to as processors, processing circuitry, and/or similar terms used herein interchangeably) that communicate with other elements within the analytic computing entity 65 via a bus, for example, or network connection. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the analytic computing entity 65 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 206 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

Memory media 206 may also be embodied as a data storage device or devices, as a separate database server or servers, or as a combination of data storage devices and separate database servers. Further, in some embodiments, memory media 206 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. An example of the embodiments contemplated herein would include a cloud data storage system maintained by a third party provider and where some or all of the information/data required for the operation of the compression system may be stored. As a person of ordinary skill in the art would recognize, the information/data required for the operation of the compression system may also be partially stored in the cloud data storage system and partially stored in a locally maintained data storage system.

Memory media 206 may include information/data accessed and stored by the analytic computing entity, such as raw data, compressed data, and/or executable data (e.g., comprising one or more modules utilized to compress the raw data into the compressed data). to facilitate the operations of the system. More specifically, memory media 206 may encompass one or more data stores configured to store information/data usable in certain embodiments.

In one embodiment, the analytic computing entity 65 may further include or be in communication with volatile media (also referred to as volatile storage, memory, memory storage, memory circuitry and/or similar terms used herein interchangeably). In one embodiment, the volatile storage or memory may also include one or more volatile storage or memory media 207 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 308. Thus, the databases, database instances, database management system entities, data, applications, programs, program modules, scripts, source code, object code, byte code, compiled code, interpreted code, machine code, executable instructions, and/or the like may be used to control certain aspects of the operation of the analytic computing entity 65 with the assistance of the processing element 205 and operating system.

As indicated, in one embodiment, the analytic computing entity 65 may also include one or more network and/or communications interfaces 208 for communicating with various computing entities, such as by communicating data, content, information, and/or similar terms used herein interchangeably that can be transmitted, received, operated on, processed, displayed, stored, and/or the like. For instance, the analytic computing entity 65 may communicate with computing entities or communication interfaces of other computing entities 65, user computing entities 30, and/or the like.

As indicated, in one embodiment, the analytic computing entity 65 may also include one or more network and/or communications interfaces 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOC SIS), or any other wired transmission protocol. Similarly, the analytic computing entity 65 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The analytic computing entity 65 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the analytic computing entity's components may be located remotely from other analytic computing entity 65 components, such as in a distributed system. Furthermore, one or more of the components may be aggregated and additional components performing functions described herein may be included in the analytic computing entity 65. Thus, the analytic computing entity 65 can be adapted to accommodate a variety of needs and circumstances.

b. Exemplary User Computing Entity

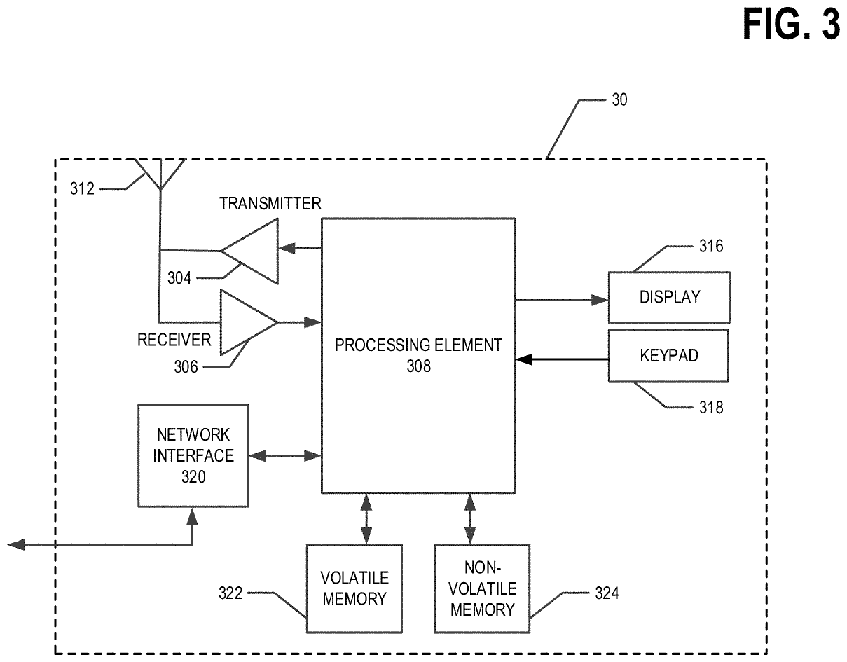

FIG. 3 provides an illustrative schematic representative of a user computing entity 30 that can be used in conjunction with embodiments of the present invention. As will be recognized, the user computing entity may be operated by an agent and include components and features similar to those described in conjunction with the analytic computing entity 65. Further, as shown in FIG. 3, the user computing entity may include additional components and features. For example, the user computing entity 30 can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as an analytic computing entity 65, another user computing entity 30, and/or the like. In this regard, the user computing entity 30 may be capable of operating with one or more air interface standards, communication protocols, modulation types, and access types. More particularly, the user computing entity 30 may operate in accordance with any of a number of wireless communication standards and protocols. In a particular embodiment, the user computing entity 30 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the user computing entity 30 can communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 30 can also download changes, add-ons, and updates, for instance, to its firmware, software (e.g., including executable instructions, applications, program modules), and operating system.

According to one embodiment, the user computing entity 30 may include location determining aspects, devices, modules, functionalities, and/or similar words used herein interchangeably. For example, the user computing entity 30 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data/data may be determined by triangulating the position in connection with a variety of other systems, including cellular towers, Wi-Fi access points, and/or the like. Similarly, the user computing entity 30 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The user computing entity 30 may also comprise a user interface comprising one or more user input/output interfaces (e.g., a display 316 and/or speaker/speaker driver coupled to a processing element 308 and a touch screen, keyboard, mouse, and/or microphone coupled to a processing element 308). For example, the user output interface may be configured to provide an application, browser, user interface, dashboard, webpage, and/or similar words used herein interchangeably executing on and/or accessible via the user computing entity 30 to cause display or audible presentation of information/data and for user interaction therewith via one or more user input interfaces. The user output interface may be updated dynamically from communication with the analytic computing entity 65. The user input interface can comprise any of a number of devices allowing the user computing entity 30 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the user computing entity 30 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the user computing entity 30 can collect information/data, user interaction/input, and/or the like.

The user computing entity 30 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the user computing entity 30.

c. Exemplary Networks

In one embodiment, the networks 135 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 135 may have any suitable communication range associated therewith and may include, for example, global networks (e.g., the Internet), MANs, WANs, LANs, or PANs. In addition, the networks 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### III. Exemplary System Operation

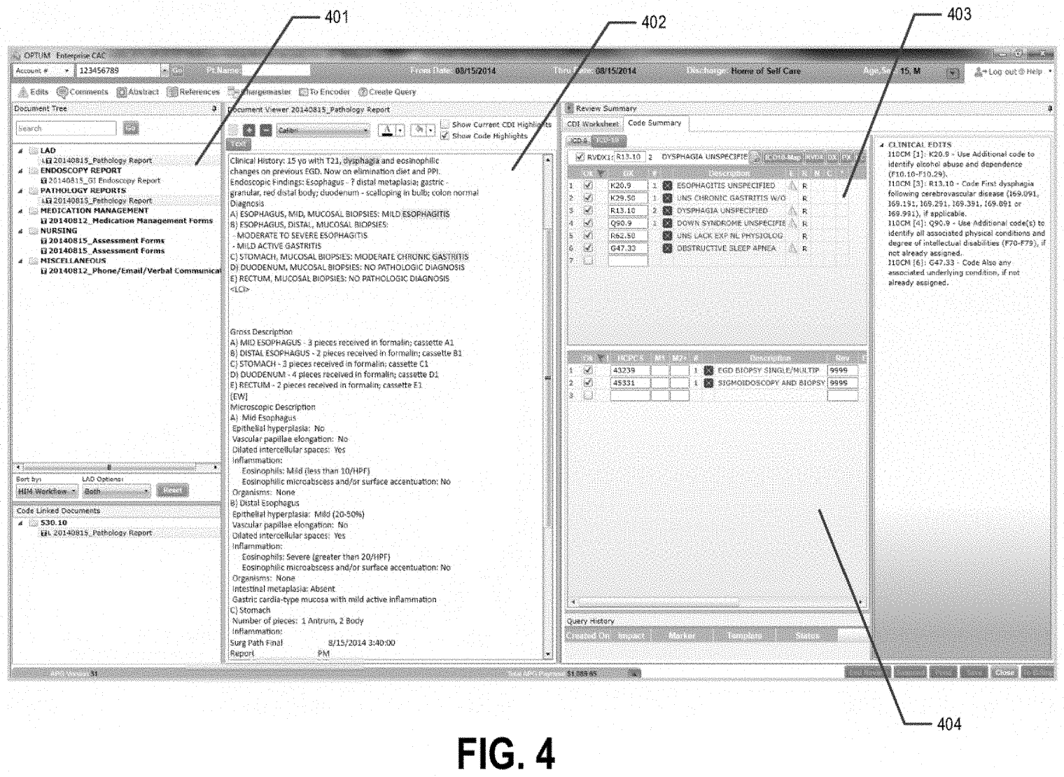

Reference will now be made to FIGS. 4-16B to describe various embodiments.

a. Overview

As indicated, there is a continuous need for concepts that efficiently utilize existing electronic storage resources, such as through data file compression methodologies. This need is becoming increasingly important within the medical industry, where the amount of medical data for individual patients and/or individual episodes of care for treating a patient is constantly growing. Within the medical industry specifically (although equally applicable in other industries characterized by similar data storage considerations), stored data is often highly repetitive, as multiple data files relating to a single patient and/or episode of care may have identical or nearly identical data stored therein. For example, physicians may choose to copy and paste the substance of patient notes through multiple, chronologically sequential data files (each file corresponding to a particular patient check-in, for example), and may only make minor changes to reflect changed observations regarding the patient. As a result, each of the plurality of data files generated for a particular patient and/or episode of care may be nearly identical, and each individual data file may be characterized by a relatively large file size due to the inclusion of the duplicative data within each data file.

Embodiments as discussed herein provide data compression concepts for use with data storage systems, such as medical data storage systems, configured for storing a plurality of data files within a data storage hierarchy, wherein individual data files are characterized by known data file types, and data files of a common data file type are generated chronologically. Data files may be further characterized by defined groupings to further designate relevant similarities between particular data files. For example, a data storage hierarchy for a related collection of files may be characterized by data stored for: a particular patient (a highest level of data characterization), for a particular episode of care relating to that patient, with a number of data file types utilized to designate individual files relating to the episode of care, and individual data files having time stamps or other metadata identifying a sequence of data files within each data file type.

Various embodiments gather files of a given file type and identify a chronological sequence of those files between an oldest file and a most-recent file of the relevant file type. The contents of files are compared to identify duplicative data by comparing the contents of chronologically adjacent pairs of data files—pairs of files of a particular file type being generated at times/dates that are sequentially adjacent. As an illustrative example, if 3 files of TYPE A are included within a particular hierarchy, with FILE 1 generated on Jan. 2, 2020 at 11:20:14 AM, FILE 2 generated on Feb. 4, 2020 at 6:15:11 AM, and FILE 3 generated on Feb. 4, 2020 at 7:35:11 PM, then FILE 1 and FILE 2 would be considered chronologically adjacent (with no files of the same file type being generated between FILE 1 and FILE 2 for the given hierarchy), and FILE 2 and FILE 3 would be considered chronologically adjacent (with no files of the same file type being generated between FILE 2 and FILE 3 for the given hierarchy), however FILE 1 and FILE 3 would not be considered chronologically adjacent, because FILE 2 was generated between FILE 1 and FILE 3.

Beginning with the oldest file, the content of each data file may be compared against the content of the chronologically adjacent data file (the data file generated sequentially and chronologically next) to determine duplicative data. The duplicative data contents are then removed from the older file, leaving only the data indicative of differences between the compared files within the older file. This process continues chronologically by comparing file pairs until reaching the most-recent file. For those file types having highly duplicative data between each file, only the most-recent file will contain the duplicative data as a result of this comparison, with the remaining, historical files each containing only data that differs from other data files within the series of data files of the particular data file type.

The process for comparing the contents of data files and removing duplicative data may proceed in a manner in which context is preserved, so as to ensure that visually similar data having differing contexts are not incorrectly deemed as duplicative. For example, certain embodiments execute these substantive comparisons within identified data segments (subsets of data within each data file), such that comparisons are made between the contents of identical data segments, and not across data segments (e.g., data captured within a “Family History” data segment is not compared against data within a “Current Diagnoses” data segment).

As a result, the file sizes of historical data files may be drastically reduced while maintaining a complete data set, as reflected within the most recent data file. Files of a particular file type (and within a common grouping, such as relating to a single patient and/or episode of care) may be linked in accordance with included metadata, such that systems in accordance with various embodiments may be configured to generate a user interface inclusive of complete data (including data removed during compression) when displaying the contents of a historical data file. Various embodiments may be configured to visually distinguish between data retrieved from a most recent file of the particular file type and data within the selected historical data file being displayed via the user interface (e.g., via differing formats, such as differing text colors, differing text highlight colors, differing fonts, and/or the like). Accordingly, human users are provided with relevant context when viewing the contents of a historical data file via a user interface that designates data as duplicative or unique. Via the same compression methodologies, the individual data files do not include duplicative data that may skew and/or otherwise impact the results of substantive data analysis, which may be performed, for example, by one or more machine-learning based systems, automated classification systems, and/or other systems seeking to utilize the data within the data storage system.

It should be understood that while embodiments are discussed herein in reference to the storage and compression of medical data, the embodiments discussed herein are equally usable for storage and compression of other data having analogous data storage hierarchies.

### 1. Technical Problem

There is a constant need for concepts that more efficiently utilize existing electronic storage resources, particularly as electronic data generation becomes more pervasive. Certain data stores that are used to store highly redundant data organized in a hierarchical fashion may be particularly well-suited to certain data compression techniques to maximize the efficiency with which those data storage resources are utilized.

### 2. Technical Solution

To provide a highly efficient compression methodology to maximize the efficiency of usage of certain data storage resources, various embodiments identify redundant data between multiple, related data files, and remove duplicative data from historical data files, thereby maintaining a single copy of the duplicative data within a most-recent related data file. Moreover, related data files may be identified, and metadata stored in association with those data files may be utilized to establish links between those related data files, such that various embodiments are configured to display complete data (inclusive of any redundant data that is only reflected within a most-recent data file) via a user interface when a user reviews a historical data file, without requiring such redundant data to be stored exclusively in relation to the historical data file.

b. Data Generation and Data Storage

In one embodiment, data may be generated at one or more computing devices, such as user computing devices 30 associated with various medical personnel. The generated data may be provided in the form of discrete data files each corresponding to a particular patient, episode of care, and/or the like. Each data file may be stored within a single data repository (e.g., a database), and each data file may comprise metadata characterizing various attributes of the data file, such as metadata identifying one or more hierarchical attributes of the data file, edit times/dates, generation times/dates, and/or the like. In other embodiments, each data file may be stored within a data repository (e.g., a database) corresponding to a particular grouping of data files, such as data files corresponding to a particular patient. These data files may be generated/viewed/modified in accordance with a file system user interface, such as that shown in FIG. 4 and described in greater detail herein.

As discussed above, generated data files of various embodiments are stored within a hierarchical data structure. Metadata associated with each data file may be utilized to implement the organizational hierarchy. As just one example, each data file may be associated with a particular patient (for example, identified based at least in part on a unique patient identifier within metadata associated with the datafile) defining a top-level of the organizational hierarchy. Each data file may be further associated with a particular episode of care (for example, identified based at least in part on a unique episode identifier within metadata associated with the datafile) defining a second-level of the organizational hierarchy. In certain embodiments, each data file may be further associated with a data file type (for example, identified based at least in part on a unique data file type identifier within metadata associated with the datafile and/or identified based at least in part on other characteristics of the datafile), defining a third-level of the organizational hierarchy.

Each data file may be a text-based data file, a form-based data file (e.g., having defined fillable fields), a multimedia data file (e.g., including photos, videos, sound files, and/or the like, such as images, videos, or sounds generated during one or more medical tests, scans, and/or the like). Each data file of certain embodiments may comprise one or more data segments containing specific data. As discussed in greater detail herein, data segments of certain embodiments need not be explicitly tagged (e.g., with metadata) defining a beginning and an end of the particular data segment. Various embodiments may comprise one or more segment identifier modules configured to parse the contents of a data file to identify the beginning and end of various data files, for example, based on characteristics of text within those data files (e.g., capitalization of text, identification of defined words within the text, identification of specified punctuation within the text, and/or the like). However, it should be understood that in certain embodiments, one or more data tags may be provided to correspond with particular contents of a data file and to identify the beginning and end of a particular data segment. As just one example, data files may be provided in XML format, with beginning data segment tags and ending data segment tags associated with the contents of the data file.

Within each data segment, data files contain substantive contents, such as textual descriptions of various patients, maladies, notes, and/or the like. As mentioned, in certain embodiments the contents of a data segment may comprise one or more multimedia contents, such as images, videos, audio files, and/or the like. These multimedia contents may be compared to identify differences between various data files by comparing whether a multimedia object is present within particular data file segments, by identifying metadata associated with each multimedia object (e.g., to identify whether a multimedia object has been modified, such as by comparing object names, object types, object creation dates/times, object sizes, and/or the like). In other embodiments, comparisons between multimedia files may proceed by comparing the contents of particular files (e.g., by looking for differences within images, differences within audio files, and/or the like, in accordance with multimedia comparison tools).

As just one example, various data files may be accessible to one or more users operating user computing entities 30 via a user interface similar to that shown in FIG. 4.

As shown in FIG. 4, the user interface may comprise a hierarchical file storage tree portion 401, illustrating available data files for a particular grouping (e.g., for a particular patient and/or for a particular episode of care). The hierarchical file storage tree portion 401 may display the available files in a hierarchical fashion, a chronological fashion, and/or the like. The display may comprise various identifying data (e.g., stored as metadata) for specific data files, such as a data file title, a data file type, a data file timestamp (e.g., indicative of a date and time when the data file was generated), a data file sequence number (e.g., indicating where, within a chronological sequence of a plurality of data files within the display, the data file was generated), and/or the like.

Moreover, the user interface of FIG. 4 includes a content display pane 402 displaying the content of a selected data file (e.g., a data file selected from the hierarchical file storage tree portion 401). The content display pane 402 may be configured for enabling read-only privileges via the user interface, or the content display pane 402 may be configured for enabling read and write privileges via the user interface. As discussed in greater detail herein, the content display pane 402 may be configured to visually distinguish between data stored within a selected data file and data retrieved from a related, most-recent data file (in other words, to distinguish between data stored within the data file and data removed from the data file as a result of data compression provided in accordance with various embodiments as discussed herein.

The user interface may comprise one or more additional display panes, which may be specifically characterized for usage within the medical data context. In the illustrated embodiment of FIG. 4, the user interface further comprises a diagnostic code pane 403 and a procedural code pane 404 each comprising data indicative of one or more codes (e.g., ICD-9 codes, ICD-10 codes, and/or the like) identified for a particular data file. The codes may be automatically generated or manually generated in accordance with certain embodiments.

c. Data File Grouping

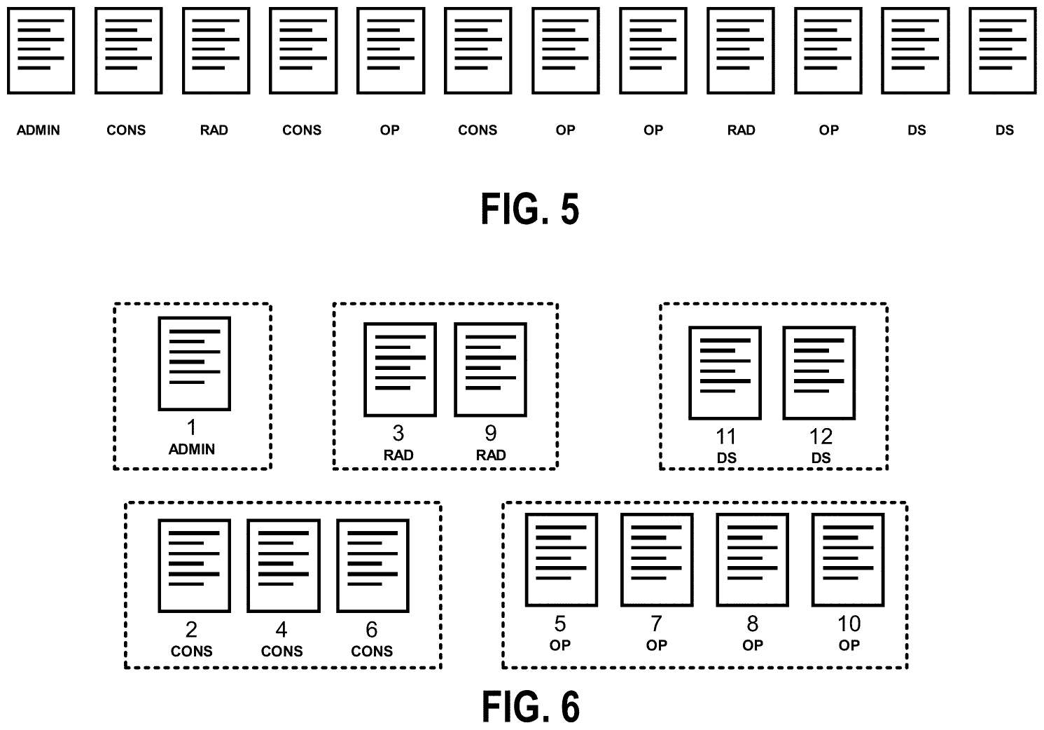

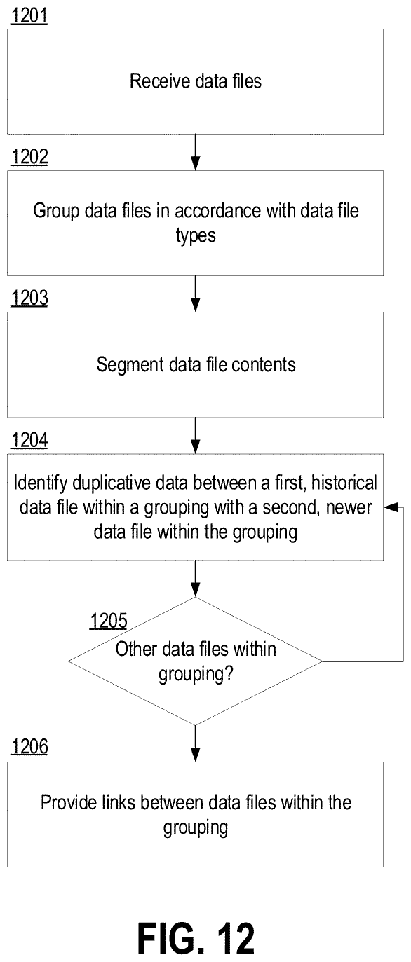

FIGS. 5-11 schematically illustrate the operation of various embodiments with respect to graphical representation of text-based data files. FIG. 12 further provides a flowchart illustrating various steps associated with certain embodiments and as represented in FIGS. 5-11.

Beginning with Block 1201 of FIG. 12, and as represented by FIG. 5, various embodiments begin with receipt of one or more data files to be stored within a particular hierarchical data storage area. With reference to the above-mentioned examples, data files may be received for a particular patient and/or episode of care for storage in a data repository. In certain embodiments, the processes as discussed in reference to FIGS. 5-12 may be executed once for a particular data repository, for example upon the occurrence of a trigger event signifying that no further data files will be generated for the particular data repository. In other embodiments, the process as discussed in reference to FIGS. 5-12 may be executed upon the generation of a new data file within a data repository, such that the data compression processes execute periodically or in real-time, upon the addition of a new data file to the data repository. It should be understood that data files may be provided to the data repository (e.g., data files may be generated) chronologically, and consecutive data files may not necessarily be of a same data type. For example, as shown in the illustration of FIG. 5, a first data file generated may be an “ADMIN” data file, a second data file may be a “CONS” data file, a third data file may be a “RAD” data file, and so on.

With reference to FIG. 6 and Block 1202 of FIG. 12, the process continues by grouping data files within a data repository based at least in part on data file type. This grouping may be accomplished by review of metadata stored in association with each data file. With reference to the illustration of FIG. 6, the grouping may organize data files based at least in part on data file type, and the groupings may retain the chronological order of generation of each data file within a particular grouping. In the example shown, the third and ninth data files generated in the illustrated example of FIG. 6 were of a “RAD” file type. Upon grouping, these “RAD” files are grouped together, and the chronological ordering of these files is retained for further processing. Similar grouping processes were provided for the “DS” data files, the “CONS” data files, and the “OP” data files. Grouping was also performed for the “ADMIN” data file, although only a single file of the “ADMIN” data file was present within the data repository, and accordingly the “ADMIN” data file grouping contains only a single data file.

d. Data File Content Segmenting

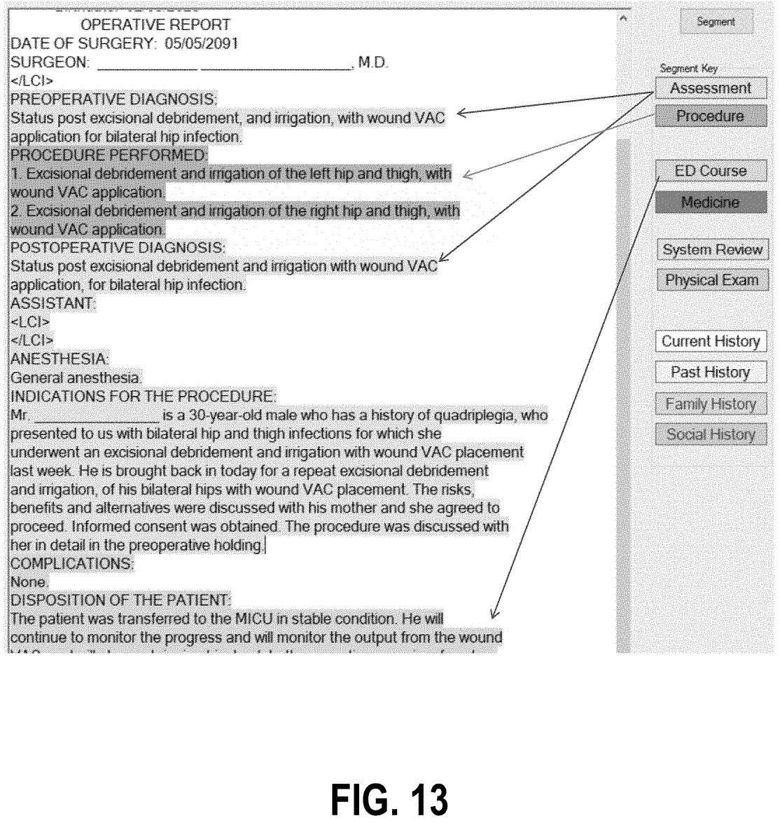

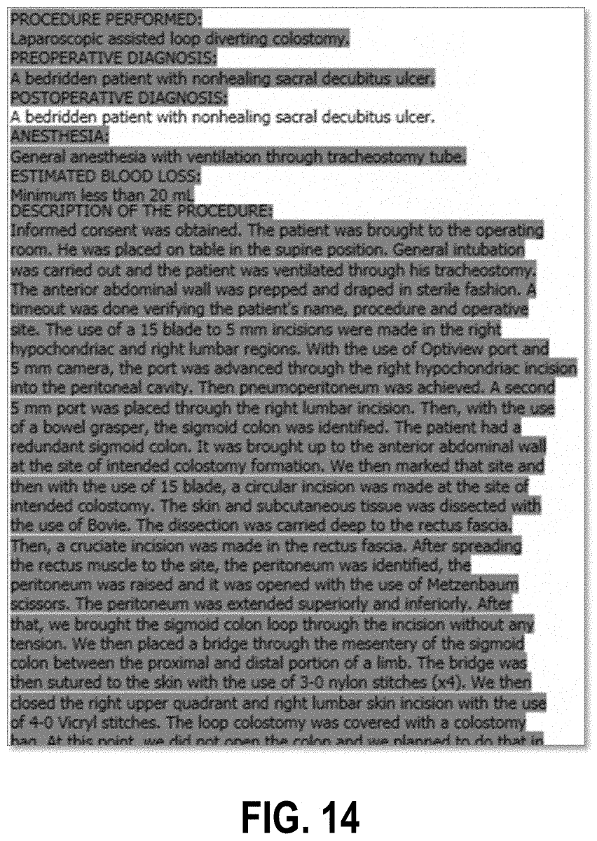

With reference to Block 1203 of FIG. 12 and FIG. 13, the contents of each data file may be segmented, so as to identify context of text within each data file. In various embodiments, data file segmenting may proceed in accordance with one or more processes as discussed in U.S. Pat. No. 6,915,254, the contents of which are incorporated herein by reference in their entirety. By segmenting the contents of each data file, identified similar file contents (e.g., text) with differing context may be appropriately distinguished, for example, during later compression processes. As just one medical-related example, data file content segmenting may enable various embodiments to distinguish between data stored within a “family medical history” portion of the data contents and a “patient medical history” portion of the data contents, such that textual contents indicating a “presence of breast cancer” written within the “family medical history” portion of the data contents is not miscontextualized as incorrectly indicating that the patient's personal medical history indicates a presence of breast cancer.

With specific reference to the example of FIG. 13, which illustrates a segmented content of a data file, segmentation may comprise processes for distinguishing between a segment beginning with the capitalized terminology “PREOPERATIVE DIAGNOSIS:”, another segment beginning with the capitalized terminology “PROCEDURE PERFORMED:”, another segment beginning with the capitalized terminology “POSTOPERATIVE DIAGNOSIS:”, and another segment beginning with the capitalized terminology “COMPLICATIONS:”. As discussed herein, various embodiments utilize differing characteristics of the contents of a data file, such as capitalization, specific identified terms, and/or the like, to identify the beginning of a data segment (which may also mark an end of a prior data segment within the same data file.

Data file content segmentation involves the processing of substantive contents of data files (e.g., physician notes) in a manner taking into account that such data files include certain information. For example, each data file (particularly data files of a given type, such as care notes) typically contains certain sections: the history of an illness being investigated/diagnosed/treated; an exam description; a description of the course of action/treatment; and a list of final diagnoses. Other sections may also be present. These include but are not limited to: chief complaint; review of systems; family, social and medical history; review and interpretation of lab work and diagnostic testing; consultation notes; and counseling notes. Because there is no uniform order or labeling for sections, the data file content segmentation processes may be configured to associate each paragraph of the data file contents with one of the required or optional segment types.

Thus, data file content segmentation generally involves processing the contents of input data files to identify section headings. Once identified, these headings are categorized and the paragraphs/lines/sentences falling within each section are associated with the corresponding section heading. Section headings provide context within which the associated paragraphs may be interpreted. For example, it is expected that the history of present illness will contain a description of a patient's symptoms including the context and setting of symptom onset and the duration and timing of the current symptoms. Automatic segmentation of the contents of the data file may be a two-step algorithmic process comprising: (1) identification of possible section headings through lexical pattern matching, and (2) resolution and categorization of section headings using vector matching with marking of section extents.

During data file content segmentation, candidate section headings may be identified using lexical patterns—specifically, regular expressions. Examples of three regular expressions used to identify possible section headings are shown below:

Pattern 1: \hat{ }[\t]*[A-Z][A-Za-z#_∧\−]+:

Pattern 2: [A-Z][A-Z#A\∧\]+:

Pattern 3: \hat{ }[\t]*[A-Z] [A-Z#_∧\−]+

A list of candidate section headings is created by scanning each line of text in the data file and comparing the scanned text against regular expressions similar to the three patterns shown above. A sequence of characters matching any of the patterns is copied into a list of candidate section headings. This list stores the section headings in the order they appear in the document along with the offsets, with respect to the original note, of the first and last characters of each section heading. The algorithm may also identify multiple section headings on a single line and a single section heading split across two lines.

The data file content segmentation configuration resolves and categorizes sections using vector matching techniques.

During vector matching, a group of individual words are compared against a set of term vectors. Each term vector in turn consists of a group of words. The individual words of each term vector are compared against the source group of words. The number of words in common between the source group and a term vector determines a degree of similarity. A perfect match would exist when both the source group and the term vector have the same number of words and there is a one-to-one identity match for every word. The set of term vectors is also classified according to domain-dependent breakdown. An example portion of a term vector database for section headings is shown below:

complaint:

chief complaint |
complaint

;
allergy:

allergy |
allergies |
allergy medication |
allergy to medication

;
system_review:

review of systems |
review of system |
systems |
ros

;
physical_exam:

pe |
physical examination |
physicial examination |
physical examintion |
physical exam |
physical findings |
physical

;

In the above example, the section categories are the terms prior to the colon in each grouping. Individual term vectors are separated by a vertical bar “|” following the section category. The vectors for one section category are terminated by a semicolon. Note, in the term vector for physical examination, the inclusion of common misspellings such as “physicial” and “examintion” for “physical” and “examination”, respectively.

During note segmentation, each candidate section heading is compared against section-heading vectors in a segment database using appropriate vector processing algorithms. The matching candidates are validated as confirmed section headings. All text characters from the end of the current section heading to the beginning of the next confirmed section heading in the contents of the data file are considered one segment. Each segment includes a copy of the text making up the section, the section category, and the offsets of the first and last character in the segment with respect to the original data file. This information is stored together in a data structure and placed on a list representing confirmed sections.

It should be understood that in certain embodiments, the compression methodologies as discussed herein may be applied for changed section headings between older and newer data files. To ensure that data is not incorrectly deleted, the contents of non-matching sections may be deleted to reflect mere changes within the section heading titles in limited circumstances in accordance with various embodiments, such as those circumstances in which the content of two sections are identical, and the only changes between the two sections are the section headings themselves.

e. Data File Content Compression

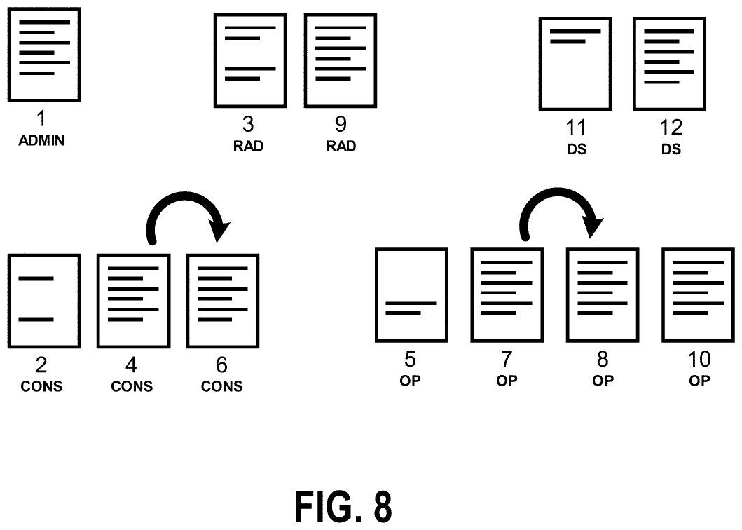

With reference again to FIG. 12, data compression processes are represented beginning with Block 1204. These processes are further represented by the illustrations of FIGS. 8-11. As illustrated and as discussed in reference to FIG. 12, compression of data within a plurality of data files of a given file type may proceed with respect to data segments within those data files, however it should be understood that in certain embodiments in which data files are not subdivided into individual data segments, data compression processes as described herein may proceed without respect to included data segments.

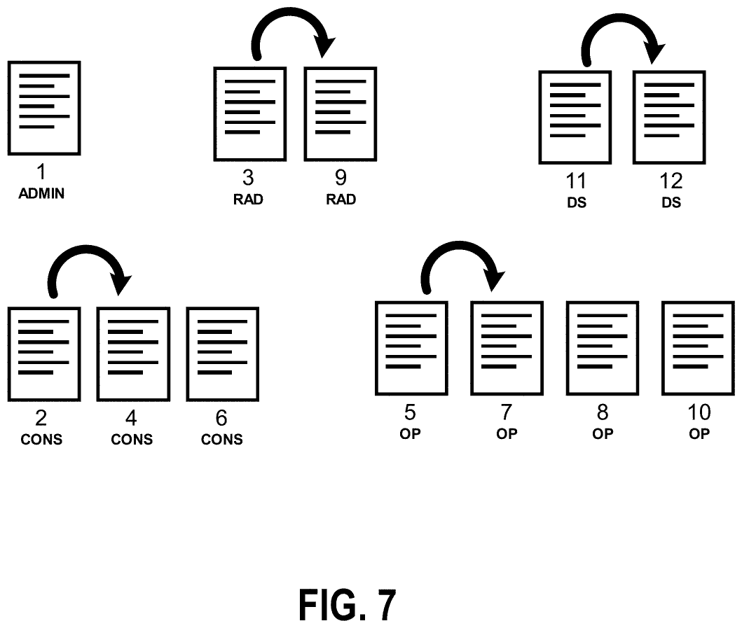

As indicated at Block 1204, the oldest data file (e.g., determined based at least in part on timestamps associated with each data file, sequence numbers associated with each data file, and/or the like) is compared against a second-oldest data file within a particular grouping to identify duplicative contents therein. Such process is reflected at FIG. 7, for example. As shown therein, an oldest “RAD” data file (having sequence number 3 in the illustrated embodiment) is compared against a second oldest “RAD” data file (having sequence number 9). Similarly, the oldest “DS” data file (having sequence number 11) is compared against the second oldest “DS” data file (having sequence number 12). The oldest “CONS” data file (having sequence number 2) is compared against the second oldest “CONS” data file (having sequence number 4). Similarly, the oldest “OP” data file (having sequence number 5) is compared against the second oldest “OP” data file (having sequence number 7). Because there is only a single “ADMIN” data file, no comparisons occur within the “ADMIN” grouping.

Comparisons proceed within individual data segments of data files. Thus, when comparing the contents of an oldest data file against a second oldest data file, these comparisons occur within shared data segments. As an example, if the oldest “CONS” data file has an “INTRODUCTION” data segment and an “OBSERVATIONS” data segment, and the second oldest “CONS” data file includes “INTRODUCTION” data segment and a “CONCLUSIONS” data segment, a comparison proceeds by comparing the contents of the “INTRODUCTION” data segments within the two data files, but no comparison takes place between the “OBSERVATIONS” and “CONCLUSIONS” data segments, because these two data segments are identified as different. Therefore, all of the contents of the OBSERVATIONS data segment is identified as different from the more recent, second oldest data file.

Based on the comparison, duplicative data is identified between the compared data files. Duplicative data may be identified as being an exact match, or one or more fuzzy matching algorithms may be utilized, for example, with defined thresholds of level-of-similarity required for a finding of duplicate data. In certain embodiments, data may be compared on a line-by-line basis within data files (a line being identified as data existing between hard-returns (also referred to as NEW LINE entries within the data file), such that duplicative data lines are identified between the two data files. As just one example, duplicative data may be identified as lines having at least a 90% similarity between the old data file and the more-recent data file (e.g., at least 90% of characters within the line match, at least 90% of words within the line match, and/or the like). However, it should be understood that identifications of duplicative data may proceed for other data subsets. For example, identifying duplicative data may comprise identifying entirely duplicative data segments; identifying duplicative words or phrases, and/or the like.

Upon identifying duplicative data, the duplicative data existing within the older data file of the comparison (e.g., the oldest data file within the grouping) is deleted from the older data file (as graphically illustrated in FIG. 8), thereby reducing the size of the older data file. As discussed herein, the deleted data from the older data file may be reconstructed later (e.g., during a viewing process, during a file-edit process, and/or the like) based on the content of one or more linked more recent files containing the duplicative data. FIG. 14 illustrates an example data file in which content has been deleted as discussed herein. In the example of FIG. 14, the comparison process identified the line of “A bedridden patient with nonhealing sacral decubitus ulcer.” as being the only line that was not a duplicate with a more recent data file, and the remaining data lines within the illustration (shown with a grey background) were deleted as a result of the compression process. As discussed in greater detail herein, the older data file remains linked with the newer data file containing the deleted data, thereby enabling the generation of a user interface analogous to that shown in FIG. 14, containing data from the older data file and the newer data file, so as to illustrate to a user what data has been removed from the older data file (e.g., by showing data that remains within the older data file in a first format, such as having a white background, and showing data that was retrieved from the linked newer data file (representing the data deleted from the older data file) in a second format, such as having a grey background).

With reference again to FIG. 12, at Block 1205, the process continues with a determination of whether any newer data files remain within each grouping. For those groups in which additional data files exist, the process continues by comparing the second oldest data file within the grouping against the third oldest data file within the grouping, as also reflected within FIG. 8. With specific reference to the graphically depicted example, the comparison process is complete for the “RAD” and “DS” groupings, which only included two documents. However, additional comparisons continue within the “CONS” and “OP” groupings, as illustrated.

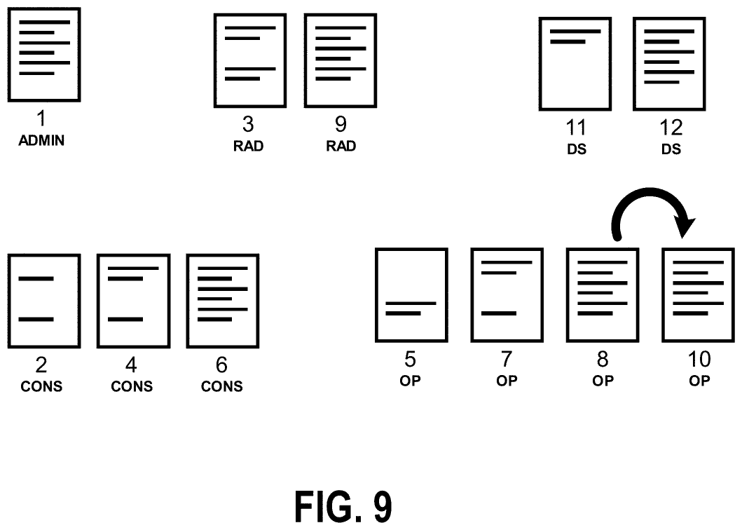

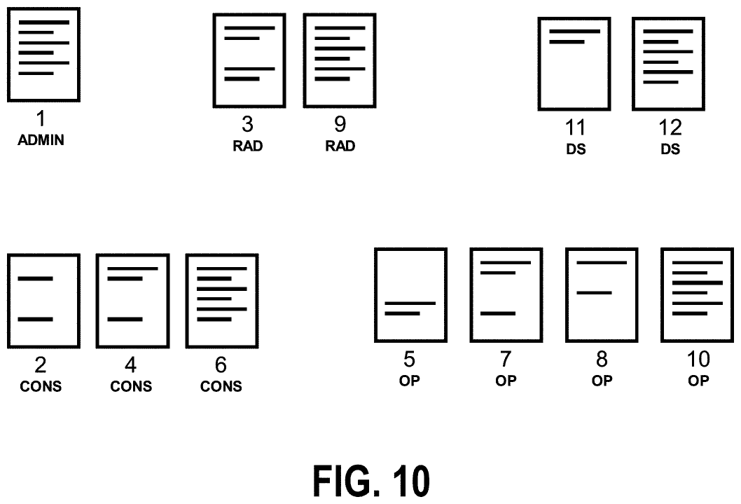

With reference briefly to FIG. 9, duplicative data is again identified as a result of the second comparison step, and the duplicative data is again removed from the older data file within the comparison. Again, the process determines whether additional data files exist within each grouping that require additional comparisons. In the illustrated embodiment of FIG. 9, the comparison process is complete for the “CONS” grouping, but continues for another iteration for the “OP” grouping. Once the process continues iterating until determining that no further comparisons are necessary in any groups, the result, as illustrated graphically in FIG. 10, is that only the most-recent data file within each grouping is not subject to potential data compression, while older historical data files within each grouping are subject to potential compression to delete data identified as duplicative with more recent data files within the same grouping. As noted herein, because the duplicative data deleted from the older data files remains within the most-recent data file (and/or one or more interim data files generated chronologically between the oldest data file and the most-recent data file), the total contents of the older data files may be reconstructed based at least in part on data links between the older data files and the most recent data file of the same file type.

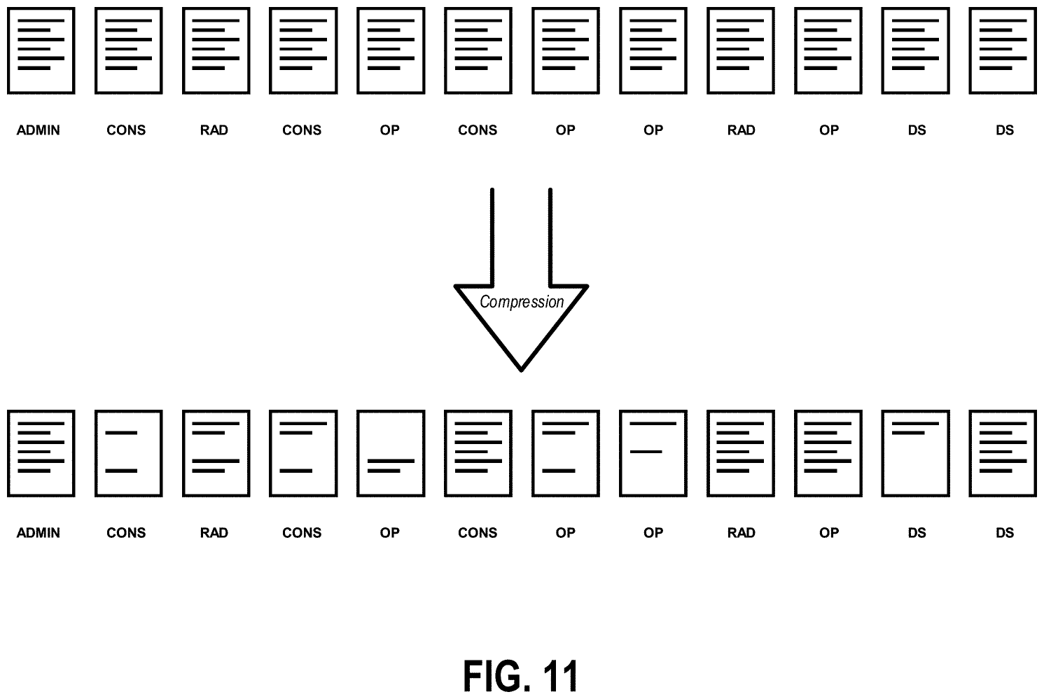

Thus, as reflected within FIG. 11, the compression process as discussed herein results in the deletion of data from a plurality of data files within a data repository, thereby reducing the file sizes of historical data files within the repository and reducing the overall storage resource requirement for maintaining a complete reflection of data within the storage repository. Because only duplicative data is deleted, no unique data is removed or lost as a result of the compression process. Moreover, the deleted data may be reconstructed after deletion (e.g., during a viewing process, during a file edit process, and/or the like) based on the content of one or more linked more recent files containing the duplicative data that was deleted from the one or more older files. Particularly for file edit processes in which the contents of an older file is edited, the compression process as discussed herein may be reinitialized with respect to the newly edited older file so as to ensure that the newly edited data that may differ from the contents of more recent files remains within the older data file.

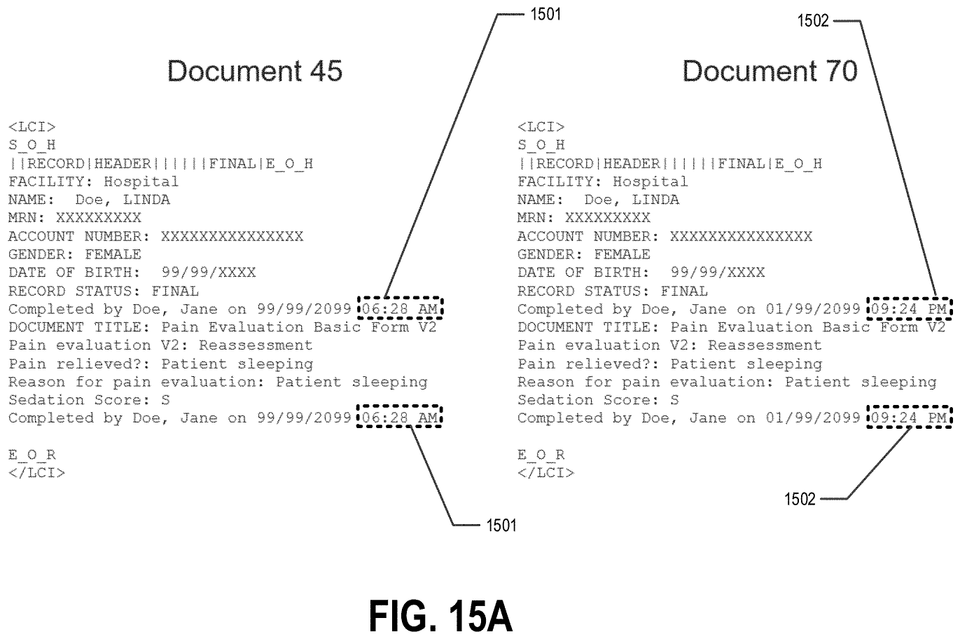

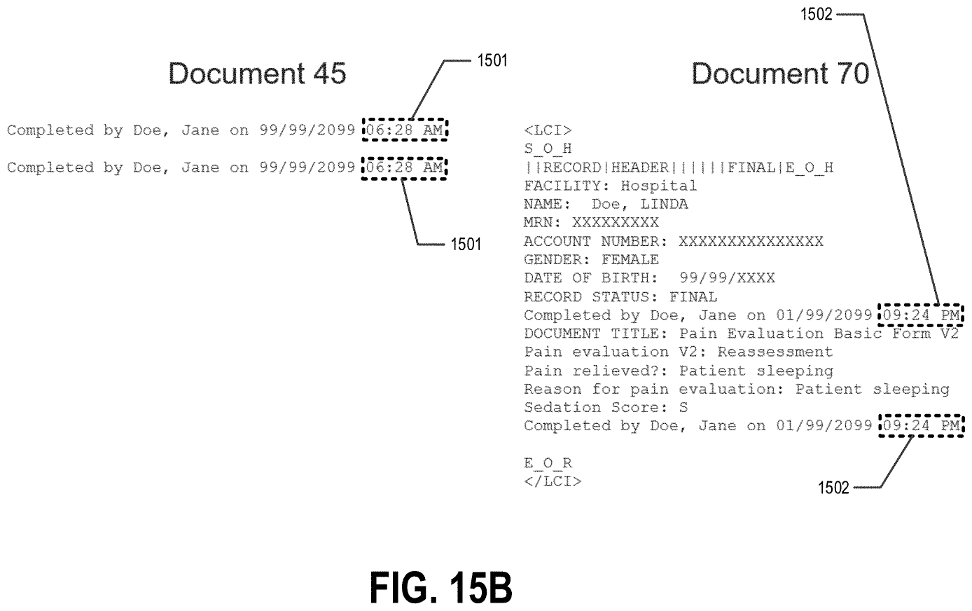

FIGS. 15A-15B illustrate one example of a comparison process between identified related documents (“Document 45” and “Document 70,” which are identified as being within a common grouping). As shown in FIG. 15A, the contents of Document 45 and Document 70 are nearly identical, with data within only 2 lines being different. Specifically, the time stamps shown (emphasized at elements 1501 and 1502) differ between the contents of Document 45 and Document 70. Accordingly, the compression process as discussed herein comprises deleting all data within the older, Document 45 data file, with the exception of the two lines identified as having differing time stamps. The result is illustrated in FIG. 15B. As shown therein, the contents of Document 45 is substantially decreased to only include the two lines containing the differing timestamps of elements 1501, while the contents of Document 70 remain complete, including all data that was identified as duplicative with the contents of Document 45.

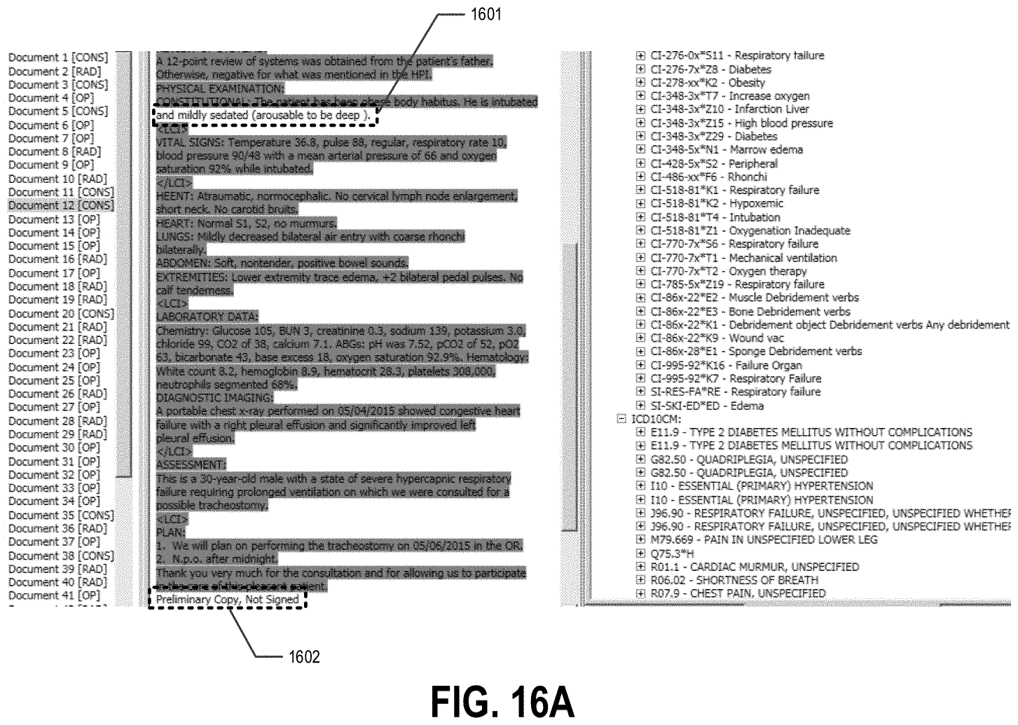

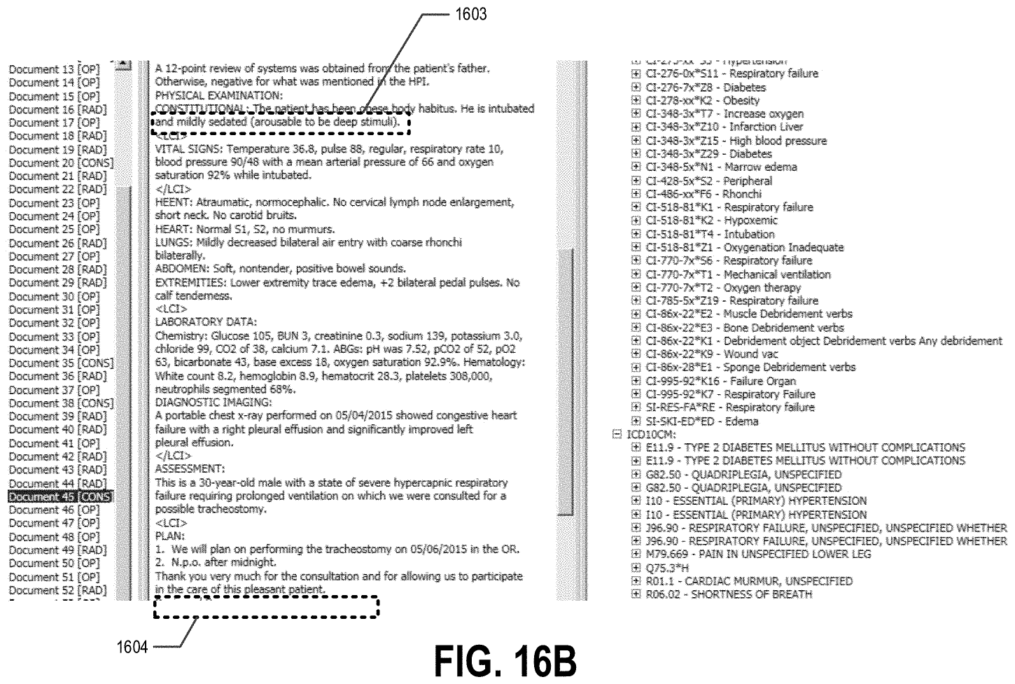

FIGS. 16A-16B illustrate another example of a comparison process between identified related documents (specifically, between “Document 12” and “Document 45” of a CONS file type). As shown in FIG. 16A, which illustrates the contents of Document 12, only 2 lines, emphasized at elements 1601 and 1602, were identified as having data different from that included within Document 45. Accordingly, all duplicative data between the two data files (shown with a grey background in the illustrated embodiment of FIG. 16A) was deleted from Document 12. During display of the contents of Document 12, the duplicative data is retrieved from Document 45 for generation of the user interface. By contrast, the contents of Document 45 (including those portions identified as different from Document 12, as indicated at elements 1603 and 1604 of FIG. 16B and those portions identified as duplicative with the contents of Document 12) remains intact and stored within Document 45.

Moreover, as indicated at Block 1206 of FIG. 12, the data repository maintains data links between data files within each identified grouping, thereby enabling processes to retrieve representations of the deleted duplicative data from more recent data files for display within a shared user interface generated for displaying the content of a historical data file. An example of such a user interface is provided at FIG. 14. Accordingly, generating a user interface for display of the contents an older data file comprises identifying a linked most-recent data file relating to the historical data file for display and retrieving the contents from the most-recent data file for display together with the data of the historical data file. In addition to the substantive contents of the historical data file, the historical data file may comprise location data utilized for organization of the contents of the historical data file and most-recent data file. Specifically, the location data may identify where, within the most-recent data file, the contents of the historical data file should be displayed. As just one example, the location data may comprise line numbers that correlate with the data stored within the historical data file, such that, when displaying the data retrieved from both the historical data file and the most-recent data file, the data of the historical data file is placed at contextually relevant locations within the generated user interface.

### f. Applications and Examples

As discussed herein, various embodiments may be configured specifically for compressing medical-related data for a particular patient, a particular episode-of-care, and/or the like. However, it should be understood that embodiments may be configured for operating within any of a variety of industries, and accordingly the discussion of medical-related data should not be interpreted to be limiting of the potential uses of embodiments discussed herein.

### 1. Human Users and Graphical User Interfaces

Humans may require significant context of data when viewing the data in order to obtain a complete understanding of the relevance of reviewed data for a particular set of circumstances. However, while this context is necessary for many users, duplicative data used solely for providing context need not be reviewed for each new data item, such as when reviewing the history of a particular patient, a particular episode-of-care, and/or the like. Accordingly, users may desire to see repetitive data, however such data may be indicated as repetitive, such that a user may determine whether particular data items should be studied in detail or simply skimmed when reviewing presented data.

Accordingly, as discussed herein, compression methodologies provided in accordance with various embodiments maintain appropriate context for data included within compressed data files through links to other, related data files, wherein such links enable display configurations to generate composite display user interfaces including data retrieved from compressed data files as well as data retrieved from related data files. The data retrieved from the related data files may be displayed with formatting distinct from the data retrieved from the compressed data files, thereby enabling a user to visually distinguish between the data obtained from each data file. FIG. 14 provides an example of a composite user interface including data from a compressed data file (illustrated in black text with a white/clear background) and data retrieved from one or more related data files (illustrated in black text with a grey background). Because the data retrieved from the related data file encompasses only duplicative data, the user can visually distinguish between data that differs between the compressed data file and the related data file based at least in part on the provided formatting, and the user can make a personal determination of whether the duplicative data should be reviewed when viewing the data from the compressed data file.

### 2. Machine-Based and Automated Analytics Uses

Various embodiments provide the benefits discussed above for enabling users to view and easily identify new, or otherwise non-duplicative data of particular data files (with respect to the contents of other, related data files), without requiring that duplicative data to be separately stored within each data file. Because the duplicative data is not separately stored multiple times (resulting in a large data storage requirement), machine-based systems utilizing the stored data need not separately identify duplicative data to ensure that the duplicative data does not impact any data-based analysis of the contents. For example, certain machine-learning based systems which may utilize the data of certain patients and/or episodes-of-care may utilize text-based weighting methodologies to classify the contents of the analyzed data. Duplicative data may skew the results of this analysis, as sometimes irrelevant data is repeated within the duplicative data to such an extent that machine-learning based classifiers may incorrectly identify such duplicative data as highly important to a particular data set encompassing a plurality of data files. Thus, by removing duplicative data entries within a collection of data files through the compression methodologies discussed herein, embodiments ensure that machine-based systems may apply appropriate weighting to the contents of collections of data files, without requiring separate embodiments/configurations for specifically identifying duplicative data within the collection of data files.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method for compressing chronological data within a data storage repository, the method comprising:
identifying related data files generated at different times, wherein the related data files comprise a first data file and a second data file, and wherein the second data file was generated chronologically after the first data file;
identifying duplicative data existing in both the first data file and the second data file;
deleting the duplicative data from the first data file; and
generating a link between the first data file and the second data file to enable retrieval of the duplicative data during display of contents of the first data file.

2. The computer-implemented method for compressing chronological data within a data storage repository of claim 1, wherein identifying related data files comprises:
identifying a plurality of data files having a shared data file type; and
identifying, within the plurality of data files having a shared data file type, the first data file and the second data file as chronologically adjacent data files.

3. The computer-implemented method for compressing chronological data within a data storage repository of claim 2, further comprising, after deleting the duplicative data from the first data file,
identifying a third data file from the plurality of data files having a shared data file type, wherein the third data file is a most-recent data file;
identifying duplicative data existing in both the second data file and the third data file;
deleting the duplicative data from the second data file;
generating a link between the first data file and the third data file to enable retrieval of duplicative data during display of the contents of the first data file; and
generating a link between the second data file and the third data file to enable retrieval of duplicative data during display of contents of the second data file.

4. The computer-implemented method for compressing chronological data within a data storage repository of claim 1, wherein identifying related data files comprises identifying related data files within a hierarchical data storage repository.

5. The computer-implemented method for compressing chronological data within a data storage repository of claim 1, further comprising:
displaying, via a graphical user interface, the contents of the first data file by:
retrieving the contents of the first data file;
retrieving, via the link, the contents of the second data file;
displaying a composite graphical user interface comprising the contents of the first data file with the duplicative data retrieved from the second data file.

6. The computer-implemented method for compressing chronological data within a data storage repository of claim 5, wherein the composite graphical user interface comprises the contents of the first data file displayed with a first formatting, and the duplicative data retrieved from the second data file displayed with a second formatting.

7. The computer-implemented method for compressing chronological data within a data storage repository of claim 1, wherein identifying duplicative data existing in both the first data file and the second data file comprises:
segmenting contents of the first data file into a plurality of data segments;
segmenting contents of the second data file into a plurality of data segments; and
comparing data within matching data segments of the first data file and the second data file to identify duplicative data.

8. A system for compressing chronological data within a data storage repository, the system comprising one or more memory storage areas and one or more processors, wherein the one or more processors are collectively configured to:
identify related data files generated at different times, wherein the related data files comprise a first data file and a second data file, and wherein the second data file was generated chronologically after the first data file;
identify duplicative data existing in both the first data file and the second data file;
delete the duplicative data from the first data file; and
generate a link between the first data file and the second data file to enable retrieval of the duplicative data during display of contents of the first data file.

9. The system for compressing chronological data within a data storage repository of claim 8, wherein identifying related data files comprises:
identifying a plurality of data files having a shared data file type; and
identifying, within the plurality of data files having a shared data file type, the first data file and the second data file as chronologically adjacent data files.

10. The system for compressing chronological data within a data storage repository of claim 9, wherein the one or more processors are further configured to, after deleting the duplicative data from the first data file,
identify a third data file from the plurality of data files having a shared data file type, wherein the third data file is a most-recent data file;
identify duplicative data existing in both the second data file and the third data file;
delete the duplicative data from the second data file;
generate a link between the first data file and the third data file to enable retrieval of duplicative data during display of the contents of the first data file; and
generate a link between the second data file and the third data file to enable retrieval of duplicative data during display of contents of the second data file.

11. The system for compressing chronological data within a data storage repository of claim 8, wherein identifying related data files comprises identifying related data files within a hierarchical data storage repository.

12. The system for compressing chronological data within a data storage repository of claim 8, wherein the one or more processors are further configured to:
display, via a graphical user interface, the contents of the first data file by:
retrieving the contents of the first data file;
retrieving, via the link, the contents of the second data file;
displaying a composite graphical user interface comprising the contents of the first data file with the duplicative data retrieved from the second data file.

13. The system for compressing chronological data within a data storage repository of claim 12, wherein the composite graphical user interface comprises the contents of the first data file displayed with a first formatting, and the duplicative data retrieved from the second data file displayed with a second formatting.

14. The system for compressing chronological data within a data storage repository of claim 8, wherein identifying duplicative data existing in both the first data file and the second data file comprises:
segmenting contents of the first data file into a plurality of data segments;
segmenting contents of the second data file into a plurality of data segments; and
comparing data within matching data segments of the first data file and the second data file to identify duplicative data.

15. A computer program product comprising a non-transitory computer readable medium having computer program instructions stored therein, the computer program instructions when executed by a processor, cause the processor to:
identify related data files generated at different times, wherein the related data files comprise a first data file and a second data file, and wherein the second data file was generated chronologically after the first data file;
identify duplicative data existing in both the first data file and the second data file;
delete the duplicative data from the first data file; and
generate a link between the first data file and the second data file to enable retrieval of the duplicative data during display of contents of the first data file.

16. The computer program product of claim 15, wherein identifying related data files comprises:
identifying a plurality of data files having a shared data file type; and
identifying, within the plurality of data files having a shared data file type, the first data file and the second data file as chronologically adjacent data files.

17. The computer program product of claim 16, wherein the computer program instructions when executed by a processor, cause the processor to, after deleting the duplicative data from the first data file,
identify a third data file from the plurality of data files having a shared data file type, wherein the third data file is a most-recent data file;
identify duplicative data existing in both the second data file and the third data file;
delete the duplicative data from the second data file;
generate a link between the first data file and the third data file to enable retrieval of duplicative data during display of the contents of the first data file; and
generate a link between the second data file and the third data file to enable retrieval of duplicative data during display of contents of the second data file.

18. The computer program product of claim 15, wherein identifying related data files comprises identifying related data files within a hierarchical data storage repository.

19. The computer program product of claim 15, wherein the computer program instructions when executed by a processor, cause the processor to:
display, via a graphical user interface, the contents of the first data file by:
retrieving the contents of the first data file;
retrieving, via the link, the contents of the second data file;
displaying a composite graphical user interface comprising the contents of the first data file with the duplicative data retrieved from the second data file.

20. The computer program product of claim 19, wherein the composite graphical user interface comprises the contents of the first data file displayed with a first formatting, and the duplicative data retrieved from the second data file displayed with a second formatting.

21. The computer program product of claim 15, wherein identifying duplicative data existing in both the first data file and the second data file comprises:
segmenting contents of the first data file into a plurality of data segments;
segmenting contents of the second data file into a plurality of data segments; and
comparing data within matching data segments of the first data file and the second data file to identify duplicative data.
